(19) United States
(12) Patent Application Publication
(10) Pub. No.: US 2008/0052270 A1
(43) Pub. Date: Feb. 28, 2008

(54) HASH TABLE STRUCTURE AND SEARCH METHOD

(75) Inventor: Tobias Karlsson, Rockville, MD (US)

Correspondence Address: ERICSSON INC., 6300 LEGACY DRIVE, M/S EVR 1-C-11, PLANO, TX, 75024, US

(73) Assignee: TELEFONAKTIEBOLAGET LM ERICSSON (PUBL), Stockholm (SE)

(21) Appl. No.: 11/466,598

(22) Filed: Aug. 23, 2006

(51) Int. Cl. G06F 17/30

(52) U.S. Cl. 707/3

(57) ABSTRACT

A device and search method are described herein which minimizes the cost associated with searching and accessing a memory to obtain a particular piece of stored data. In one embodiment, the device performs the following steps: (1) input search information into a hash function; (2) run the hash function which outputs a first set of information; (3) access a search database (located in static random access memory (SRAM)) to determine an index number of an element therein that contains a second set of information which matches the first set of information outputted by the hash function; and (4) access a result database (located in dynamic random access memory (DRAM)) to obtain the particular piece of data that is stored within an element therein which has an index number that matches the index number of the element within the search database that contained the second set of information which matched the first set of information outputted by the hash function.

### BACKGROUND OF THE INVENTION

1. Field of the Invention

The present invention relates in general to the computer field and, in particular, to a device and a method for minimizing the cost associated with searching and accessing a memory to obtain stored data.

2. Description of Related Art

Electrical engineers/computer scientists are constantly trying to develop new devices which can be used to minimize the cost associated with searching and accessing a memory to obtain stored data. One such device which utilizes a hash function and a search method to access a hash table (including two databases based on two different memory technologies) and obtain a particular piece of stored data is the subject of the present invention.

### BRIEF DESCRIPTION OF THE INVENTION

A device and search method are described herein which minimizes the cost associated with searching and accessing a memory to obtain a particular piece of stored data. In one embodiment, the device performs the following steps: (1) input search information into a hash function; (2) run the hash function which outputs a first set of information; (3) access a search database (located in static random access memory (SRAM)) to determine an index number of an element therein that contains a second set of information which matches the first set of information outputted by the hash function; and (4) access a result database (located in dynamic random access memory (DRAM)) to obtain the particular piece of data that is stored within an element therein which has an index number that matches the index number of the element within the search database that contained the second set of information which matched the first set of information outputted by the hash function.

### BRIEF DESCRIPTION OF THE DRAWINGS

A more complete understanding of the present invention may be obtained by reference to the following detailed description when taken in conjunction with the accompanying drawings wherein:

FIG. 1 is a block diagram of a device which minimizes the costs associated with searching and accessing a memory (hash table) to obtain a particular piece of the stored data in accordance with the present invention;

FIGS. 2A and 2B respectively illustrate a search database and a result database that make-up the hash table incorporated within the device shown in FIG. 1;

FIG. 3 is a flowchart that illustrates the steps of a method for searching and accessing a particular piece of data stored in a hash table in accordance with the present invention;

FIG. 4 is a diagram of a hash function used by the device shown in FIG. 1 and the method shown in FIG. 3 to help access the particular piece of data in accordance with the present invention; and

FIG. 5 is a flowchart that illustrates the steps of a method for adding data to the search database and the result database shown in FIGS. 2A and 2B in accordance with the present invention.

### DETAILED DESCRIPTION OF THE DRAWINGS

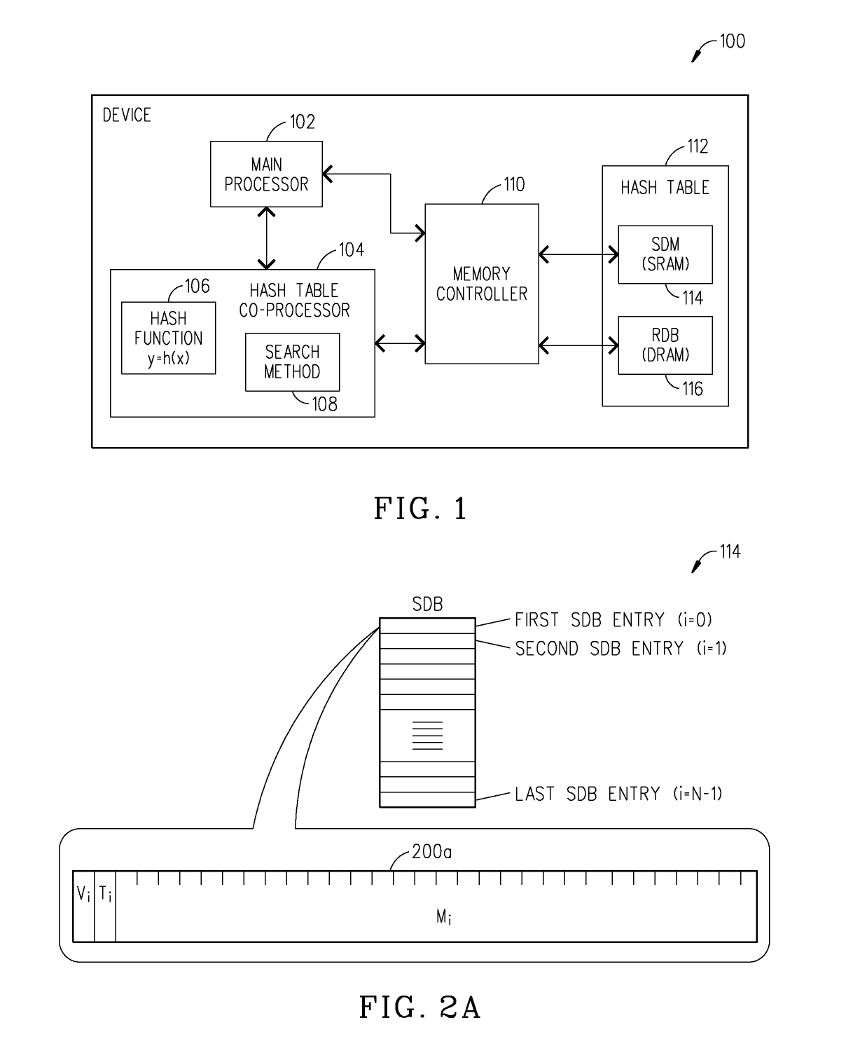

FIG. 1 is a block diagram of a device 100 which minimizes the cost associated with searching and accessing a memory to obtain a particular piece of stored data in accordance with the present invention. The device 100 includes a main processor 102, a hash table co-processor 104 (which implements a hash function 106 and a search method 108), a memory controller 110 and a hash table 112 (which includes a search database 114 and a result database 116). Basically, the hash table co-processor 104 runs the hash function 106 and search method 108 and interacts with the memory controller 110 to access information which is stored within the search database 114 and then uses the result of that search which is an element numberᵢ to access the corresponding element numberᵢ in the result database 116 to obtain the desired piece of stored data. A wide-variety of devices could implement the search method 108 so long as those devices have a processor 102, a hash function 106, and a two-part hash table 112.

The hash table 112 has two parts including the search database 114 (which is involved with the hash function 106) and the result database 116 (which contains the resulting data of the search and is application specific). In one embodiment, the search database 114 is based on static random access memory (SRAM). And, the result database 116 is based on dynamic random access memory (DRAM). The SRAM is generally faster, more flexible and allows for more efficient access of smaller quantities of data when compared to DRAM. For instance, the most efficient data size per access in a SRAM is typically 32 or 64 bits while the same metric for a DRAM would be 128 bits (or larger). The device 100 uses these two different memory technologies (the SRAM and DRAM) to in the greatest extent possible, utilize the bandwidth of the memory devices when searching for and accessing stored data.

In particular, the device 100 is able to better utilize memory bandwidth by first searching/accessing the search database 114 (stored in SRAM) to find a relatively small amount of information (e.g., element number) that is then used to directly access and obtain the relatively large amount of desired data which is stored in the result database 116 (stored in DRAM). The memory bandwidth is minimized per search because the required data units needed from the search database 114 well match the optimal data unit size of a SRAM. In other words, the hash table co-processor 104 does not have to search the larger/slower result database 116 to obtain the desired piece of data but instead searches/accesses the smaller/faster search database 114 to obtain information which is then used to directly access the larger/slower result database 116 to obtain the desired piece of data. This is advantageous because it eliminates possible wasteful entry reads into the larger/slower result database 116.

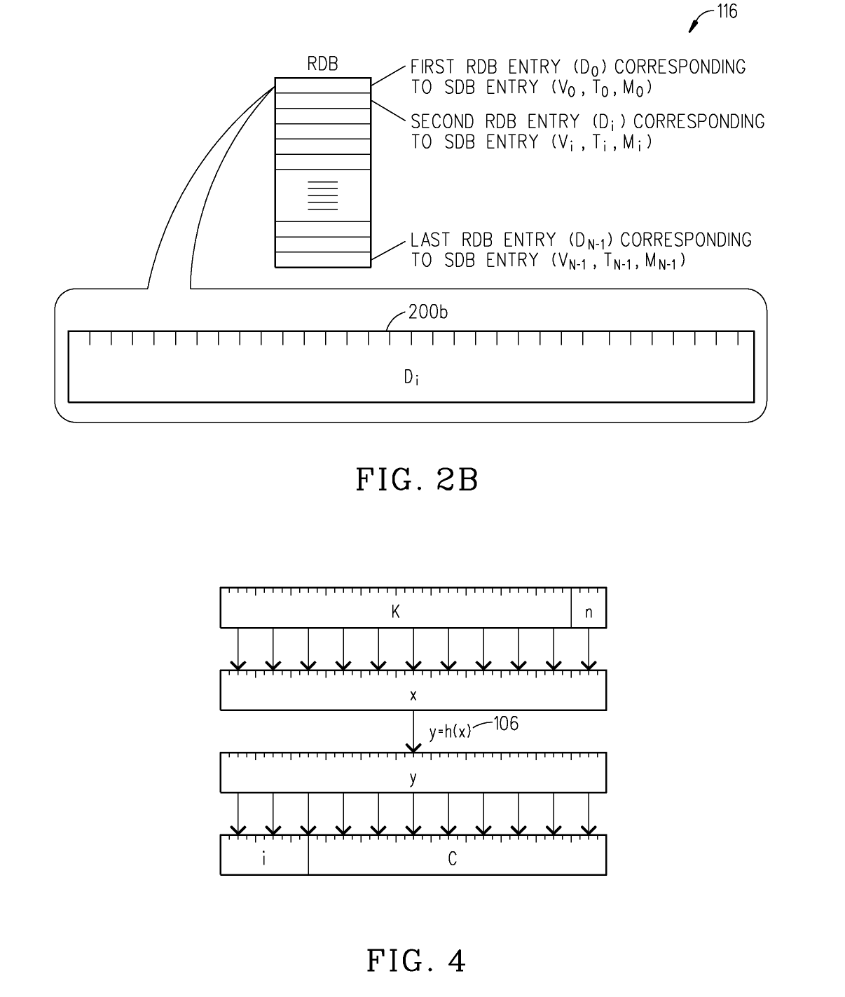

FIGS. 2A and 2B show the elements 200a and 200b which are respectively associated with the search database 114 and the result database 116. In one embodiment, the search database 114 and the result database 116 each have the same number of elements 200a and 200b. And, each element 200a in the search database 114 is associated by location with each element 200b in the result database 116. In particular, the Nth element 200a in the search database 114 is associated with the Nth element 200b in the result database 116. Each element 200a in the search database 114 has the following fields (where i signifies the position of the particular element 200a): (1) Valid Flag (Vᵢ), 1 bit; (2) Try Again Flag (Tᵢ), 1 bit; and (3) Match field (Mᵢ), remaining part of the particular element 200a (see FIG. 2A). Each element 200b in the result database 116 has a data field (Dᵢ) (see FIG. 2B). Preferably, the number of elements 200a and 200b in both the search database 114 and the result database 116 is a power of 2 (i.e., N=2^{m}).

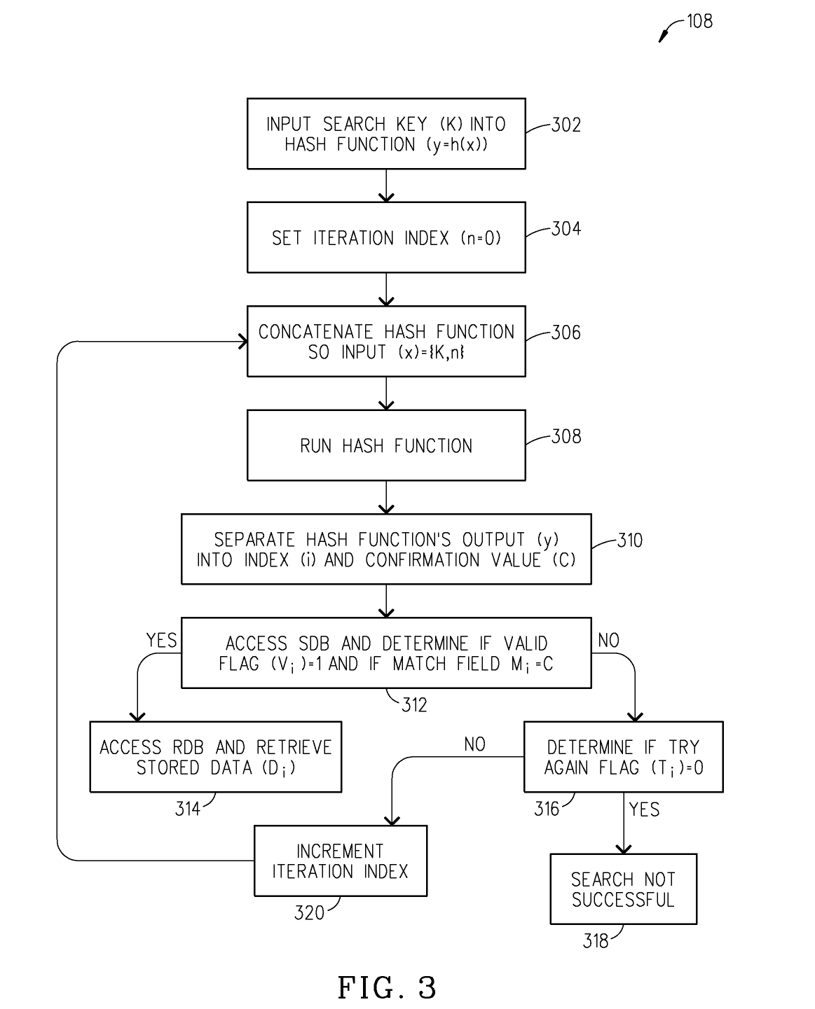

FIG. 3 is discussed next to explain how the hash table co-processor 104 runs the hash function 106 and implements the search method 108 so it can interact with the memory controller 110 to access and search for information which is stored within the search database 114 and then use the result of that search which is an element numberᵢ to directly access the corresponding element numberᵢ in the result database 116 and obtain the desired piece of stored data. In one embodiment, the hash table co-processor 104 implements the search method 108 by first inputting a search key (K) (e.g., a telephone number) into the hash function 106 (y=h(x)) and setting an iteration index n=0 (steps 302 and 304). The hash table co-processor 104 then concatenates the input (x) of the hash function (y=h(x)) such that the input (x) is a reversible function of the search key (K) and the iteration index (n) (step 306).

The hash table co-processor 104 runs the hash function 106 and obtains an output (y) which is then separated into an index (i) and a confirmation value (C) (steps 308 and 310 and FIG. 4). In one embodiment, the hash function 106 is reversible which means that the output (y) has as many combinations as the input (x)(i.e. same size in bits) and for each output value there is only one, and always one, input value. Another way of stating this is that if y=h(x) represents the hash function 106, then there is a function g for which y=h(g(y)) is true for all possible values of y. The reversible hash function 106 is used herein because it is assumed that the cost of running the hash function 106 is significantly lower than the cost associated with the traditional method of directly accessing and searching a memory to obtain stored data.

In addition, the hash function 106 should be of a high quality where a discussion is provided next to help explain a measurement which is associated with a high quality hash function 106. First, assume two randomly selected keys K₁ and K₂, where K₁≠K₂. Further assume a randomly selected value of n which means with the described hash algorithm 106 that the index for K₁ and K₂ are i_{1,n} and i_{2,n,} respectively. Now, the likelihood of i_{1,n}=i_{2,n} should roughly be 1 in N, where N is the size of the hash table 112 (in number of elements). Furthermore, again assume two random keys K₁ and K₂ (not equal) and a random value on n for which i_{1,n}=i_{2,n}. Now, for any value of m (m≠n) the likelihood of i_{1,m}=i_{2,m} should roughly be 1 in N. This type of hash function 106 also allows one to balance the hash table 112 so as to help reduce the worst case search time.

Referring back to FIG. 3, the hash table co-processor 104 after step 310 then interacts with the memory controller 110 and uses the index (i) to access the search database 114 and determine if a valid flag (Vᵢ) in elementᵢ was true (“1”) and if a match field (Mᵢ) was the same as the confirmation value (C) (step 312). If yes, the hash table co-processor 104 interacts with the memory controller 110 to access the result database 116 and retrieve the data (Dᵢ) (e.g., name of person with phone number that was used as the search key (K)) stored in elementᵢ (step 314).

To help illustrate the operation of steps 302, 304 . . . 314, the following example is used in which the search database 114 and the request database 116 are populated as indicated in TABLE 1:

TABLE 1

| K_{i: phone #} | Rᵢ | SDB: (V_{i,} T_{i,} Mᵢ) | | | RDB: D_{i: (name)} |
|---|---|---|---|---|---|
| 240-555-1234 | 0 | 1 | | 0x2c96c82d | Jane |
| 301-555-9910 | 1 | 1 | 1 | 0x25513622 | Joe |
| 919-555-4567 | 0 | 1 | | 0x1221489d | John |
| | 0 | | | | |
| | 0 | | | | |
| 202-555-8831 | 0 | 1 | | 0x30955bf5 | Julie |
| 703-555-0725 | 1 | 1 | 1 | 0x2904f290 | Jack |
| | 0 | | | | |

### Note: How this exemplary search database 114 and this exemplary result database 116 are populated is discussed below after the discussion about the search method 108.

In this example, assume that the user of the device 100 (e.g., mobile phone 100) wants to search for the name of the person who has the phone number 919-555-4567. To accomplish this, the phone number 919-555-4567 (search key (K)) and the iteration index n=0 are input into the hash function 106 which yields i=2, C=0x1221489d (steps 302, 304 . . . 310). The element₂ in the search database 114 has a valid V₂=1 and its match field M₂ does match C (step 312). As a result, the device 100 concludes that there is a match and then accesses element₂ in the result database 116 to obtain the result in D₂ (“John”) (step 314).

Referring back to FIG. 3, if the result of step 312 was false, then the hash table co-processor 104 determines if the try again flag (Tᵢ) in elementᵢ of the search database 114 is false (“0”) (step 316). If yes, then the hash table co-processor 104 indicates that the search for the stored data was not successful (step 318). If no, the hash table co-processor 104 increments the iteration index (n) by one and then uses the search key (k) and the incremented iteration index (n+1) to repeat the concatenating step 306, the running step 308, the separating step 310 and the accessing steps 312 and 314 in an attempt to retrieve the stored data (see step 320). Note: steps 306, 308, 310, and 312 can be repeated so long as the current n<S, where S is the highest current depth (or number of elements) of the search database 114 and the result database 116. The S value can be maintained by keeping an array of entry counters (Hₙ). One Hₙ counter per table depth such that if an entry is added at depth n, then the corresponding Hₙ counter needs to be increased by one. The table depth value S, is then the lowest value for which Hₙ=0, n≧S (see TABLE 5).

Referring again to the example associated with TABLE 1, assume that the user of the device 100 (e.g., mobile phone 100) wants to search for the name of the person who has the phone number 240-555-1234. Then, this phone number 240-555-1234 (search key (K)) and the iteration index n=0 are input into the hash function 106 which yields (i=6, C=0x35ad9bcb) (steps 302, 304 . . . 310). The element₆ in the search database 114 has a valid V₆=1 but its match field M₆ (0x2904f290) does not match C (0x35ad9bcb) (steps 312 and 316). However, since T₆ is set to true “1”, the hash table co-processor 104 increments the iteration index to n=1 and repeat steps 306, 308, 310, and 312 (steps 316 and 320). The hash function 106 this time outputs i=0 and C=0x2c96c82d. Looking at M₀ and V₀, the hash table co-processor 104 concludes that there is a match and then accesses element₀ and obtains the result D₀ (“Jane”) from the result database 116 (steps 312 and 314).

Another way to describe the search method 108 shown in FIG. 3 is provided below:

### START:

Input: search key K
Set n=0

### LOOP:

Concatenate the hash function input x={K, n}
Run hash function: y=h(x)
Separate out i and C from y. The log₂ N first bits of y are assigned to i, where N is the number of entries of the SDB 114 (and needs to be a power of 2). The remaining bits form C.
If Vᵢ is false (‘0’), goto NEXT.
If C is not equal to Mᵢ, goto NEXT.
Search finished successfully. The application specific result is stored in Dᵢ.

### NEXT:

If Tᵢ is false (‘0’), goto NOMATCH
Increment n: n=n+1
If n<S, goto LOOP

### NOMATCH:

Search finished without match!

### Note: the search method 108 could be used to search multiple positions in parallel which would reduce the latency of the search.

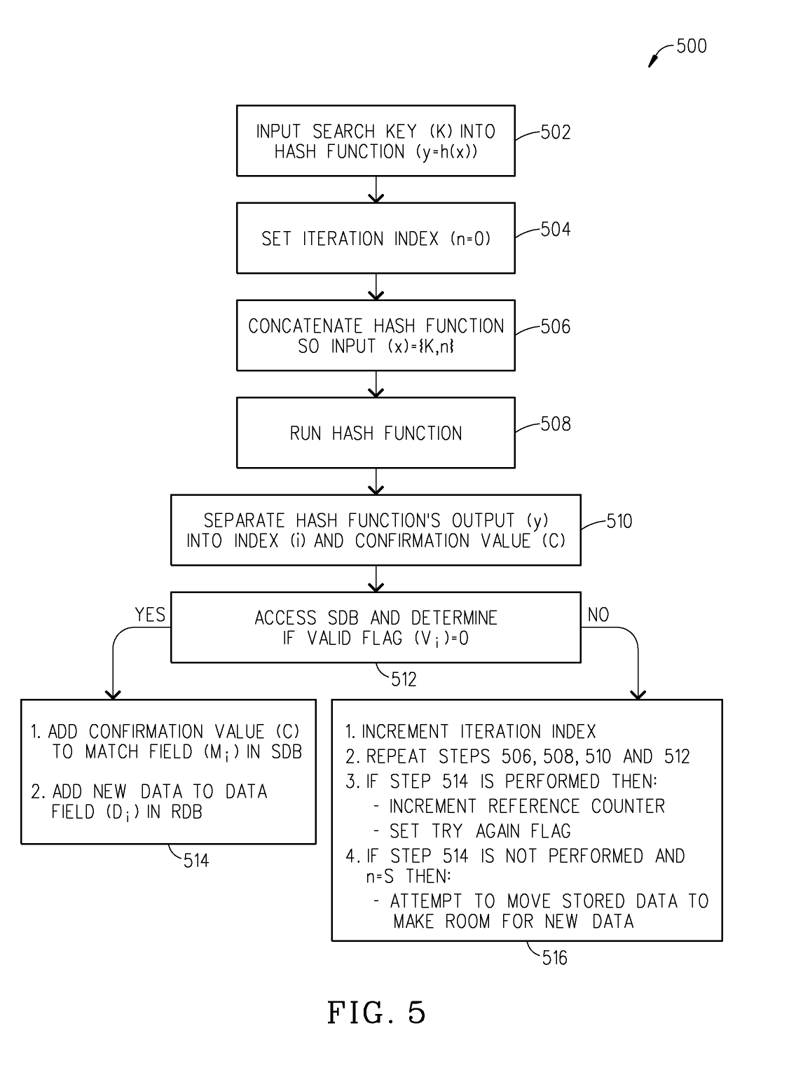

FIG. 5 is a flowchart which illustrates an exemplary method 500 that the hash table co-processor 104 can use to add data to the search database 114 and the result database 116. As shown, the hash table co-processor 104 starts by inputting a search key (K) (e.g., a telephone number of the new person) into the hash function 106 (y=h(x)) and setting an iteration index n=0 (steps 502 and 504). The hash table co-processor 104 then concatenates the input (x) of the hash function (y=h(x)) such that the input (x) is a function of the search key (K) and the iteration index (n) (step 506). The hash table co-processor 104 then runs the hash function 106 and obtains an output (y) which is separated into an index (i) and a confirmation value (C) (see steps 508 and 510 and FIG. 4). Thereafter, the hash table co-processor 104 interfaces with the memory controller 110 to access the search database 114 and determine if a valid flag (Vᵢ) in elementᵢ was false (“l ”) (step 512). If yes, then the hash table co-processor 104 adds the confirmation value (C) to a match field (Mᵢ) in elementᵢ of the search database 114 and then accesses the result database 116 and adds the new data (e.g., name of person with phone number that was used as the new search key (K)) into a data field (D1) of elementᵢ (step 514).

To help illustrate the operation of steps 502, 504 . . . 514, the following examples are provided where several entries were added to an eight (8) entries large hash table 112. Each entry includes a key that is a phone number and a result data entry that is the name of the person with that phone number. The table depth (S) is fixed at “2” (the hash table 112 is not managed dynamically in the examples discussed herein). In a first example, assume that the user of the device 100 (e.g., mobile phone 100) wants to add one entry for “John” who has phone number 919-555-4567 to the search database 114 and the result database 116. To accomplish this, the hash table co-processor 104 inputs the phone number 240-555-4567 (search key (K)) and iteration index n=0 into the hash function 106 which yields (i=2, C=0x1221489d) (steps 502, 504 . . . 510). The hash table co-processor 104 determines that the valid flag (V₂) in element₂ was false (“0”) and then adds the confirmation value (C) to a match field (M₂) in element₂ of the search database 114 (steps 512 and 514). The hash table co-processor 104 also accesses the result database 116 and adds the new data (e.g., “John”) into a data field (D₂) of element₂ (step 514). This result is illustrated in TABLE 2:

TABLE 2

| K_{i: phone #} | Rᵢ | SDB: (V_{i,} T_{i,} Mᵢ) | | RDB: D_{i: (name)} |
|---|---|---|---|---|
| | 0 | | | |
| | 0 | | | |
| 919-555-4567 | 0 | 1 | 0x1221489d | John |
| | 0 | | | |
| | 0 | | | |
| | 0 | | | |
| | 0 | | | |
| | 0 | | | |

In a second example, assume that the user of the device 100 (e.g., mobile phone 100) wants to add entries for “Jane” and “Joe” who respectively have phone numbers 240-555-1234 and 301-555-9910 to the search database 114 and the result database 116. To accomplish this, the hash table co-processor 104 inputs the phone number 240-555-1234 (search key (K)) and iteration index n=0 into the hash function 106 which yields (i=6, C=0x35ad9bcb) (steps 502, 504 . . . 510). The hash table co-processor 104 determines that the valid flag (V₆) in element₆ was false (“0”) and then adds the confirmation value (C) to a match field (M₆) in element₆ of the search database 114 (steps 512 and 514). The hash table co-processor 104 also accesses the result database 116 and adds the new data (e.g., “Jane”) into a data field (D₆) of element₆ (step 514). The same process can be performed for “Joe” wherein the running of the hash function (for n=0) results in i=1 and C=0x25513622 and since V₁ was false “0” this data was added to the search database 114 and the result database 116. This result is illustrated in TABLE 3:

TABLE 3

| K_{i: phone #} | Rᵢ | SDB: (V_{i,} T_{i,} Mᵢ) | | RDB: D_{i: (name)} |
|---|---|---|---|---|
| | 0 | | | |
| 301-555-9910 | 0 | 1 | 0x25513622 | Joe |
| 919-555-4567 | 0 | 1 | 0x1221489d | John |
| | 0 | | | |
| | 0 | | | |
| | 0 | | | |
| 240-555-1234 | 0 | 1 | 0x35ad9bcb | Jane |
| | 0 | | | |

Referring back to FIG. 5, if the result of step 512 was false (where the corresponding valid flag was true “1” which means that this particular entry was not available), then the hash table co-processor 104 increments the iteration index (n) by one and then uses the search key (K) and the incremented index (ntl) to repeat the concatenating step 506, the running step 508, the separating step 510, and the accessing step 512 in an attempt to store the new data in the result database 116 (step 516). If the hash table co-processor 104 is able to store the new data in the result database 116, then a reference counter (Rᵢ) is incremented by one and the try again flag (Tᵢ) is set to true (“1”) for the elementᵢ identified before steps 506, 508 and 510 were repeated (step 516).

The try again flag (Tᵢ) is set to true (“1”) to indicate to method 500 that it should continue searching since there is at least one entry that could have fit into the specific element but that entry had to be put into another element with a higher n. To maintain this flag, a separate array of reference counters Rᵢ can be used (one counter per element). Each reference counter Rᵢ is increased by one every time an entry into the hash database 112 had to skip over a corresponding element because that element was being used at the time. Essentially, the try again flag Tᵢ needs to be set to true (“1”) if Rᵢ is non-zero. The try again flag Tᵢ might be set to true (“1”) for an empty element (Vᵢ=0). When removing entries, the reverse process take place. Note: the reference counter database R₀ . . . R_{N-1} is not part of the search database 114 but it does need to be accessible by the hash table management logic to be able to maintain the Tᵢ flag. The same is true for the Hₙ counters (see TABLE 5).

To help illustrate the operation of steps 512 and 516, the aforementioned example using TABLE 3 is continued where the hash table co-processor 104 attempts to add an entry for “Julie” who has the phone number 202-555-8831 to the search database 114 and the result database 116. To accomplish this, the hash table co-processor 104 inputs the phone number 202-555-8831 (search key (K)) and iteration index n=0 into the hash function 106 which yields (i=1, C=0x34564378) (steps 502, 504 . . . 510). The hash table co-processor 104 determines that the valid flag (Vᵢ) in elementᵢ was true (“1”) (step 512). As such, the hash table co-processor 104 increments the iteration index by one and then uses the search key (k) and the incremented index (ntl) to repeat steps 506, 508, 510 and 512 (step 516). In this case, the hash function 106 outputs i=5 and C=0x30955bf5. Looking at V₅ which is set to false “0”, the hash table co-processor 104 then adds the confirmation value (C) to a match field (M₅) in element₅ of the search database 114 (steps 512 and 514). The hash table co-processor 104 accesses the result database 116 and adds the new data (e.g., “Julie”) into a data field (D₅) of element₅ (step 514). In addition, the hash table co-processor 104 also sets the try again flag T₁=1 and increments the reference counter R₁=1 for element₁ which was identified during the initial running of steps 502, 504 . . . 510. This result is illustrated in TABLE 4:

TABLE 4

| K_{i: phone #} | Rᵢ | SDB: (V_{i,} T_{i,} Mᵢ) | | | RDB: D_{i: (name)} |
|---|---|---|---|---|---|
| | 0 | | | | |
| 301-555-9910 | 1 | 1 | 1 | 0x25513622 | Joe |
| 919-555-4567 | 0 | 1 | | 0x1221489d | John |
| | 0 | | | | |
| | 0 | | | | |
| 202-555-8831 | 0 | 1 | | 0x30955bf5 | Julie |
| 240-555-1234 | 0 | 1 | | 0x35ad9bcb | Jane |
| | 0 | | | | |

Referring back to FIG. 5, if the hash table co-processor 104 is not able to store the new data in the result database 116 and the iteration index (n) has been increased until it matches a table depth (S) (step 516—part 4). Then, the hash table co-processor 104 attempts to move previously stored data and associated information into available elementsᵢ within the search database 114 and the result database 116 to make room to add the new data and associated information into the recently cleared elementsᵢ of the search database 114 and the result database 116 (step 516—part 4).

To help illustrate part 4 of step 516, the aforementioned example is continued where the hash table co-processor 104 attempts to add an entry for “Jack” who has the phone number 703-555-0725 to the search database 114 and the result database 116. To accomplish this, the hash table co-processor 104 inputs the phone number 202-555-8831 (search key (K)) and iteration index n=0 into the hash function 106 which yields (i=6, C=0x2904f290) (steps 502, 504 . . . 510). The hash table co-processor 104 determines that the valid flag (Vᵢ) in elementᵢ was true (“1”). As a result, the hash table co-processor 104 increments the iteration index to n=1 and repeats steps 506, 508, 510, and 512. This time, the hash function 106 outputs i=1 and C=0x4959fd93. Looking at V₁ which is set to true “1”, the hash table co-processor 104 then attempts to move the previously stored data (D₆) associated with “Jane” into available elementsᵢ within the search database 114 and the result database 116. The hash table co-processor 104 runs the hash function 106 on Jane's phone number 240-555-1234 and n=1 and obtains i=0, M=0x2c96c82d. Thus, the hash table co-processor 104 moves Jane's information into elements₀ and Jack's information is moved into elements₆ in the search database 114 and the result database 116. The hash table co-processor 104 also sets the try again flag T₆=1 and increments the reference counter R₆=1. This result is illustrated in TABLE 5 (note this is same as TABLE 1):

TABLE 5

| K_{i: phone #} | Rᵢ | SDB: (V_{i,} T_{i,} Mᵢ) | | | RDB: D_{i: (name)} |
|---|---|---|---|---|---|
| 240-555-1234 | 0 | 1 | | 0x2c96c82d | Jane |
| 301-555-9910 | 1 | 1 | 1 | 0x25513622 | Joe |
| 919-555-4567 | 0 | 1 | | 0x1221489d | John |
| | 0 | | | | |
| | 0 | | | | |
| 202-555-8831 | 0 | 1 | | 0x30955bf5 | Julie |
| 703-555-0725 | 1 | 1 | 1 | 0x2904f290 | Jack |
| | 0 | | | | |

NOTE: For this exemplary hash table 112, the Hₙ array would have the following values: H₀=3 (Joe, John, Jack), and H₁=2 (Jane and Julie). Hₙ for all other n's is ‘0’. In other words, S=2 for this table.

Pseudo code (basically C) is provided next to show how the hash table co-processor 104 can implement steps 502, 504 . . . 516 to populate the search database 114 and the result database 116:

```
  hash_add (Key, Data, mode) {
  int path[MAXN];
  int n;
  for (n=0 ; n < S ; n++) {
    // Run hash function: {i, C} = y = f({Key, n})
    {i, C} = hash (Key, n);
    // Store path for later update of ’try-again’ flags
    path[n] = i;
    // If the valid bit is ’0’, then we found an available entry
    if (!V(i))
      goto SetEntry;
    else if (mode == PERSISTENT) {
    // If ’persistent’, try to move the entry in location ’i’ to somewhere
    else
    int st = hash_add (K[i], D[i], NONPERSISTENT);
    if (st == SUCCESS) {
      // If that succeeded, remove it from location ’i’ and put the new
      entry here
      hash_remove (i);
      goto SetEntry;
    }
    }
  }
  // If we did just run this procedure in ‘non-presistent’ mode and failed,
  // then try again in ’persistent’ mode
  if (mode != PERSISTENT)
    return hash_add (Key, Data, PERSISTENT);
  // If we get here, it either means that the table is full, or that there exists
  // no possible way of re-arranging entries to fit the new one. If possible
  // and acceptable, increase ’S’ and try again.
  return FAILED;
  SetEntry:
  // Put the new entry in location ’i’
  M[i] = C;
  D[i] = Data;
  V[i] = 1;
  // Update ’try-again’ flags of ’passed’ entries
  for (int x=0 ; x < n ; x++) {
    R[path[x]]++;
    T[path[x]] = 1;
  }
  return SUCCESS;
}
```

The following pseudo code (basically C) is provided to show how the hash table co-processor 104 can remove a specific data entry from the search database 114 and the result database 116:

```
hash_remove (int i) {
  for (int n=0 ; n < S ; n++) {
  int ii = hash (K[i], n, 0);
  if (ii = i)
    break;
  R[ii]−−;
  if (R[ii] == 0)
    T[ii] = 0;
  }
  V[i] = 0;
}
```

Note: in this code it is assumed that the search key (K) of each entry is stored in an array accessible to the hash table co-processor 104. However, it is also possible that the hash table co-processor 104 can calculate the search key via a reverse hash function {K, n}=f¹(y), where y={i, Cᵢ}.

The hash table co-processor 104 can implement different methods so it can populate the search database 114 and the result database 116. For instance, the hash table co-processor 104 can try to find an available element (Vᵢ=0) by iterating n from 0 to the highest current depth of the table minus one (S−1). That is, if S=3, then try n=0, 1, 2. If no such element is available, then pick a random n in the same range, calculate the position i, and attempt to move the entry currently in that position to some other element (the random picking of n differs from method 500 in which n is sequentially incremented). The process of moving an entry implies picking another n value for that entry, calculating its alternative position, and trying to fit it there. If that position is also taken, then recursively try to move that entry and continue this recursion until an empty entry has been found. In this way, a previous entry can be moved to a new position so that the new entry can be added.

These two population schemes and other population schemes should under normal conditions (with a good hash function 106 and a fairly high number of free elements in the hash table 112) be able to find an entry without having to recourse a large number of times. However, if there are very few available elements left, then it might take a long time for the population scheme to find those available elements. Further, there are theoretical cases where it is impossible for the population scheme to succeed even though there are empty elements available. For example, there could be a subset of search keys a for which the set β of possible positions (for all n<S) are all filled with search keys from α. Here, there is no way to add another key if all its possible positions are also within set β. This situation can be taken care of by anyone of the following options (for example):
1. Maintain a separate database (of some other kind) which contains entries for which the add operation required too many recursions (and had to be cancelled). Any time the search method 108 fails (does not find a match), then the hash table co-processor 104 needs to continue and search this separate database. The separate database could be a simple list of entries or something more elaborate.
2. Maintain a pre-selected preferred highest depth P and use that in the entry population scheme. However, if the population scheme does not seem to succeed, then increase the preferred highest depth P (where highest increase depth P<S). Theoretically, this might fail so strictly speaking one may still need to implement a separate database.

Although one embodiment of the present invention has been illustrated in the accompanying Drawings and described in the foregoing Detailed Description, it should be understood that the present invention is not limited to the disclosed embodiment, but is also capable of numerous rearrangements, modifications and substitutions without departing from the spirit of the present invention as set forth and defined by the following claims.

What is claimed is:

1. A device, comprising:
a processor that inputs search information into a hash function and then uses information output from said hash function to access a hash table and obtain a particular piece of data stored within said hash table, said hash table includes:
a search database which is accessed to determine an index number of an element that contains information which matches the information outputted by said hash function; and
a result database which is accessed to obtain said particular piece of data that is stored within an element which has an index number that matches the index number of the element within said search database that contained the information which matched the information outputted by said hash function.

2. The device of claim 1, wherein:
said search database is associated with a static random access memory (SRAM); and
said result database is associated with a dynamic random access memory (DRAM).

3. The device of claim 1, wherein said search database and said result database each have an equal number of elements and each element in said search database is associated by location with each element in said result database.

4. The device of claim 1, wherein said hash function is a reversible hash function in which for each output value there is only one input value.

5. A method for accessing a particular piece of data, said method comprising the steps of:
inputting search information into a hash function;
running said hash function which outputs a first set of information;
accessing a search database to determine an index number of an element therein that contains a second set of information which matches the first set of information that was outputted by said hash function; and
accessing a result database to obtain said particular piece of data that is stored within an element therein which has an index number that matches the index number of the element within said search database that contained the second set of information which matched the first set of information that was outputted by said hash function.

6. The method of claim 5, wherein:
said search database is associated with a static random access memory (SRAM); and
said result database is associated with a dynamic random access memory (DRAM).

7. The method of claim 5, wherein said search database and said result database each have an equal number of elements and each element in said search database is associated by location with each element in said result database.

8. The method of claim 5, wherein said hash function is a reversible hash function in which for each output value there is only one input value.

9. In a device which has a processor that uses a hash function and a search method to obtain a particular piece of data stored within a hash table, said search method comprising the steps of:
inputting a search key (K) into said hash function (y=h(x));
setting an iteration index (n) to an initial value in said hash function;
concatenating an input (x) of said hash function to be function of said search key (K) and said iteration index (n);
running said hash function to obtain an output (y);
separating said output (y) of said hash function into an index (i) and a confirmation value (C);
accessing a search database and determining if a valid flag (Vᵢ) in elementᵢ was true “1” and if a match field (Mᵢ) was the same as the confirmation value (C);
if yes, accessing a result database and retrieving said data (Dᵢ) stored in elementᵢ; and
if no, determining if a try again flag (Tᵢ) in elementᵢ of said search database was false (“0”);
if yes, indicating the search for said data was not successful; and
if no, incrementing the iteration index (n) and then use the search key (k) and the incremented iteration index (ntl) to repeat said concatenating step, said running step, said separating step and said steps of accessing the search database and the result database in attempt to obtain said stored data.

10. The method of claim 9, further comprising a step of adding new data to said result database by:
inputting a new search key (K) associated with the new data into said hash function (y=h(x));
setting a new iteration index (n) to an initial value in said hash function;
concatenating a new input (x) of said hash function to be function of said new search key (K) and said new iteration index (n);
running said hash function to obtain a new output (y);
separating said new output (y) of said hash function into an index (i) and a new confirmation value (C);
accessing said search database and determining if a valid flag (Vᵢ) in elementᵢ was false “0”;
if yes, adding the confirmation value (C) to a match field (Mᵢ) in the elementᵢ and then accessing said result database and adding the new data into a data field (Dᵢ) of elementᵢ; and
if no, incrementing the new iteration index (n) and then use the new search key (k) and the new incremented iteration (ntl) to repeat said concatenating step, said running step, said separating step, and said step of accessing the search database in an attempt to store the new data in a data field (Dᵢ) of element i in said result database; and
if the new data is stored, then incrementing a reference counter (Rᵢ) and setting the try again flag (Tᵢ) to true “1” in elementᵢ of said search database; and
if the new data can not be stored and the new iteration index (n) has been increased until it matched a table depth (S), then try moving a previously stored data and associated information into available elementsᵢ in both said search database and said result database to make room to add the new data and associated information into the recently cleared elementsᵢ in both said search database and said result database.

11. The method of claim 9, wherein:
said search database is associated with a static random access memory (SRAM); and
said result database is associated with a dynamic random access memory (DRAM).

12. The method of claim 9, wherein said search database and said result database each have an equal number of elementsᵢ and each elementᵢ in said search database is associated by location with each elementᵢ in said result database.

13. The method of claim 9, wherein said hash function is a reversible hash function in which for each output value there is only one input value.
